(19) United States
(12) Patent Application Publication
(10) Pub. No.: US 2021/0144006 A1
(43) Pub. Date: May 13, 2021

(54) A Traceable Method of the Blockchain Data

(71) Applicant: DATA ASSURANCE AND COMMUNICATIONS SECURITY RESEARCH CENTER, CHINESE ACADEMY OF SCIENCES, Beijing (CN)

(72) Inventors: Tianjun Ma, Beijing (CN); Haixia Xu, Beijing (CN); Peili Li, Beijing (CN); Yongheng Mu, Beijing (CN)

(21) Appl. No.: 16/640,804

(22) PCT Filed: Oct. 29, 2018
(86) PCT No.: PCT/CN2018/112283

§ 371 Date: Feb. 21, 2020

(30) Foreign Application Priority Data
Aug. 1, 2018 (CN) 2018108620640

(51) Int. Cl. H04L 9/32; H04L 9/06; H04L 9/08; H04L 9/14

(52) U.S. Cl. CPC H04L 9/3218; H04L 9/3236; H04L 9/14; H04L 9/0869; H04L 9/0836; H04L 9/0643

(57) ABSTRACT

A traceable method for the blockchain data is disclosed. A regulator generates the public parameters pp. Each user generates his own registration information and sends it to the regulator. The regulator verifies the registration information of each user, and makes some information public. When the data in the blockchain application needs the public information and identity proofs of the users who indirectly participate in data creation, each user in A_{create} obtains the identity proofs of the users in Bₒₜₕₑᵣ; each user in A_{create} creates his own identity proof, then generates the data data_{trace}=[{proof_{id}}_{id∈I}, data_{body}]_{crytool} and sends it to the node network. The node network verifies the received user data and adds it to the block. The regulator then obtains data from the blockchain and decrypts the ciphertexts in the data to determine the identity set corresponding to each data.

### TECHNICAL FIELD

The present application relates to the field of information security technology and to a design scheme of the blockchain traceability mechanism. Specifically, the present application leverages chameleon hash, zero-knowledge Succinct Non-interactive Argument of Knowledge (zk-SNARK), and other technologies to trace blockchain users' privacy information, and to ensure the security and overall efficiency of protocol execution.

### BACKGROUND OF THE INVENTION

In the 21st century, with the rapid development of the Internet, cloud computing, big data, artificial intelligence, and other technologies, the entire society is becoming more and more digital, networked, and intelligent. The blockchain technology, which has received much attention from industry and academia, has the properties of digitalization, networking, intelligence, and immutability of data. These properties make the blockchain better meet the needs of today's social development. Nowadays, the blockchain technology has good application prospects in many fields, such as, military, finance, Internet of Things, cloud computing, artificial intelligence, communications, insurance, and medical care.

The blockchain is originated from Bitcoin proposed by Satoshi Nakamoto, which is the core supporting technology of Bitcoin. It enables direct peer-to-peer payment between users without the existence of a central institution. The blockchain can be considered a distributed database (distributed ledger) that only appends data. The data is stored in the block that contains the block header and block body. Every block header includes the hash of the previous block, forming a chain. The blockchain includes a variety of features: distributed, decentralized, anonymity, safe, reliable, transparency, and so on. The blockchain is not a single technology, but an integration of multiple technologies, such as, cryptography and peer-to-peer networking.

Presently, research on blockchain primarily focuses on enhancing blockchain privacy protection, improving blockchain scalability, and analyzing blockchain security. However, it ignores providing a regulatory mechanism for the blockchain data. Strong privacy protection facilitates criminal activities (e.g., ransomware, money laundering). The lack of effective supervision in blockchain has seriously hindered the development and application of the blockchain.

### SUMMARY OF THE INVENTION

Therefore, for the actual needs of the development of the blockchain, the presently application disclose a blockchain traceable scheme. This scheme allows only the regulator to monitor data in the blockchain, and obtain the user's private information, such as user identity, data content, while others cannot obtain user's private information. Therefore, the regulator can effectively crack down on illegal and criminal activities in the blockchain by supervising the blockchain data via the traceable scheme, which ensures healthy and stable development of the blockchain.

The presently disclosed method leverages cryptographic techniques (e.g., chameleon hash, zk-SNARK) to realize the construction of a traceable scheme for blockchain:

### 1. Chameleon Hash Scheme

Definition 1.1 A chameleon hash scheme cham_hash=(Setup, KeyGen, Chash, UForge) described below:
Setup(λ): On input a security parameter λ, the algorithm returns the public parameters pp;
KeyGen(pp): On input the public parameters pp, the algorithm returns a pair of public/private keys (HK,CK), where CK is also known as the trapdoor;
Chash(HK, m, r): On input the public key HK, a message m, and a random number r, the algorithm returns a chameleon hash CH;
UForge(CK, m, r, m′): On input the private key CK, two messages m, m′, and a random number r, the algorithm returns r′ that satisfies CH=Chash(HK, m, r)=Chash(HK, m′, r′).

Definition 1.2 A chameleon hash scheme satisfies the following secure properties.
Collision resistance: On input the public key HK, there is no effective algorithm that can find two pairs (m₁, r₁) and (m₂, r₂) such that Chash(HK, m₁, r₁)=Chash(HK, m₂, r₂).
Trapdoor collisions: In the case of knowing the trapdoor, for any m₁, r₁, given m₂, there is an effective algorithm to calculate r₂, which satisfies Chash(HK, m₁, r₁)=Chash(HK, m₂, r₂).
Semantic security: For any messages m₁, m₂, the probability distribution of Chash(HK, m₁, rᵢp and Chash(HK, m₂, r₂) is indistinguishable. In particular, when r is randomly selected, the arbitrary probabilistic polynomial-time algorithm cannot obtain any information concerning m from Chash(HK, m, r).

The presently disclosed method uses the chameleon hash scheme proposed by Hugo Krawczyk and Tal Rabin:
Setup(λ): On input a security parameter λ, this algorithm constructs two large prime number p, q such that p=kq+1, and then selects the element g of order q in the multiplication cyclic group Zₚ*. Finally, this algorithm outputs a public parameter pp=(p, q, g);
KeyGen(pp): On input the public parameter pp, this algorithm randomly samples x in the multiplication cyclic group Z_{q}*, and computes h=g^{x}. Finally, this algorithm returns private key CK=x and public key HK=h;
Chash(HK, m, r): On input public key HK=h, a message m, and a random number r, where m, r e Z_{q}*, this algorithm returns the chameleon hash CH=g^{m}h^{r} mod p;
UForge(CK, m, r, m′): On input private key CK=x, a message m, a random number r, and a message m′, where m, r, m′∈Z_{q}*, this algorithm obtains m+xr=m′+xr′ mod q according to CH=g^{m}h^{r}=g^{m′}h^{r′} mod p. Therefore, this algorithm can compute r′.

### 2. Zero-Knowledge Succinct Non-Interactive Arguments of Knowledge

Definition 2.1 The arithmetic circuit satisfiability problem of an F-arithmetic circuit AC: Fⁿ×F^{h}→F^{l} is captured by the relation R_{AC}={(statement, witness)∈Fⁿ×F^{h}|AC(statement,witness)=0^{l}}; its language is L_{AC}={statement∈Fⁿ|∃witness∈F^{h} s.t. AC(statement,witness)=0^{l}}.

Definition 2.2 A zk-SNARK scheme Å=(Gen, Prove, Verify) of the language L_{AC} (with the relation R_{AC}) is described below:
Gen: On input a security parameter λ and an F-arithmetic circuit AC, this algorithm returns a pair of proving/verification key (pk, vk);
Prove: On input the proving key pk, (statement, witness), this algorithm returns a proof π for the statement using the witness;
Verify: On input vk, statement, π, this algorithm returns 1 if the verification succeeds, or 0 if the verification fails.

In addition, the presently disclosed method uses the publicly verifiable zk-SNARK. That is, (pk, vk) is disclosed as public parameters.

### 3. Public Key Encryption Scheme

Definition 3.1 A public key encryption scheme Γ=(Setup, KeyGen, ENC, DEC) is described below:
Setup(λ): Given a security parameter λ, this algorithm returns the public parameters pp_{enc}.
KeyGen(pp_{enc}): Given the public parameters pp_{enc}, this algorithm returns a pair of public/private keys (pk_{enc}, sk_{enc}).
ENC (pk_{enc}, m): Given the public key pk_{enc} and a message m, this algorithm returns a ciphertext C.
DEC (sk_{enc}, C): Given the private key sk_{enc} and the ciphertext C, this algorithm returns a message m, or returns ⊥ if decryption fails.

Aiming at the problem that the data in the existing blockchain cannot be effectively monitored, the purpose of the presently disclosed method is to provide a data traceable scheme in the blockchain.

The technical scheme of the presently disclosed method is:

The steps of the presently disclosed data traceable method for blockchain include:

1) The regulator first generates the public parameters pp; Each user generates his own registration information C_{loginfo} and sends it to the regulator;

2) The regulator verifies the registration information of each user, and publishes the h∥CH_{id} corresponding to each user's identity, where h is the chameleon hash public key, and CH_{id} is the chameleon hash value of the identity id.

3) When the data in the blockchain application needs to the public information and identity proof of the users who indirectly participate in data creation, each user in A_{create} directly obtains the identity proof of the users in Bₒₜₕₑᵣ; each user in A_{create} creates his own identity proof, generates the data data_{trace}=[{proof_{id}}_{id∈I}, data_{body}]_{crytool}, and sends it to the node network, where {proof_{id}}_{id∈I} denotes the identity proof set of users, proof_{id} is the identity proof of the user whose identity is id, I is the user identity set that requires identity proofs, A_{create}={a₁, . . . , aₙ} denotes the public information set of the users who directly participate in data creation, Bₒₜₕₑᵣ={b₁, . . . , bₙ′} denotes the public information set of the users who indirectly participate in data creation, data_{body} denotes the data body, which is also includes the users' public information set that does not require any identity proof, and crytool denotes the cryptographic tools.

4) Whenever the verification node in the node network receives the data, it verifies the identity proof of each user and the data contents. If the verification is successful, the data is added in the block that is created by the verification node. And then the node network according to a consensus mechanism selects a final block which is added to the blockchain;

5) The regulator obtains the data from the blockchain, and decrypts the corresponding ciphertext in the data, and then queries the relevant records to obtain the identity set corresponding to each data.

Further, the public parameter

pp=(pk_{loginfo}, vk_{loginfo}, pk_{idproof}, vk_{idproof}, pkₐᵤ, pp_{chash}) where (pk_{loginfo}, vk_{loginfo}) is the zk-SNARK proving/verification key for proving (statement, witness)∈R_{loginfo}, (pk_{idproof}, vk_{idproof}) is the zk-SNARK proving/verification key for proving (statement′, witness′)∈R_{idproof}, pkₐᵤ is the public key of the regulator, pp_{chash} is the chameleon hash public parameter, statement=(id, g, h, CH_{id}), witness=(x, r), the relation R_{loginfo}={(statement, witness)|h=g^{x}ΛCH_{id}=g^{id}h^{r}}; statement′=(rt, pub, g, pkₐᵤ, C_{id}), witness'=(path_{id}, CH_{id}, x, h, priv, r′, rn), the relation R_{idproof}={(statement′, witness′)|pub=gen(priv)Λh=g^{x}ΛCH_{id}=cham_hash. CHash(h, priv, r′)ΛC_{id}=Γ.ENC(pkₐᵤ, rn, h)ΛTreeBranch(rt, path_{id}, h∥CH_{id})}; g is the element of order q in the multiplication cyclic group Zₚ*, x that is the private key of computing CH_{id} is a random element in the multiplication cyclic group Z_{q}*, r is the random number of computing CH_{id}, rt is the root of the Merkle tree, path_{id} is the path from h∥CH_{id} to rt, pub is the public information, priv is the private information, rn is the random number for encryption, h∥CH_{id} corresponding to the identity of the registered user is exposed in the form of a Merkle tree.

Further, the user uses the zk-SNARK proving algorithm Prove(pk_{loginfo},statement,witness) to generate the proof π_{loginfo}. π_{loginfo} is used to prove to the regulator that the user knows that witness makes the (statement, witness) satisfy the relation R_{loginfo}, but does not disclose any information about the witness. Next, the user stores (id, g, h, CH_{id}, x, r), encrypts (statement, π_{loginfo}) using the public key of the regulator to obtain the registration information C_{loginfo}, and sends C_{loginfo} to the regulator.

Further, when the regulator receives the registration information C_{loginfo}, it will decrypt the C_{loginfo} and obtain (statement, π_{loginfo}) Next, the regulator first verifies the identity id and then invokes the zk-SNARK verification algorithm Verify(vk_{loginfo}, statement, π_{loginfo}) to verify whether the user knows that the witness makes the (statement, witness) satisfy the relation R_{loginfo}. If the verification is successful, the regulator stores (h, id, CH_{id}), and publishes h∥CH_{id} stored in the Merkle tree.

Further, the method of generating identity proof: After a user whose identity is id has successfully registered, the user can obtain the path path_{id} about his h∥CH_{id} from the Merkle tree published by the regulator. Then, according to the public/private information (pub, priv), the user can calculate a value r′=cham_hash.UForge(CK, id, r, priv). Next, the user computes ciphertext C_{id}=Γ.ENC(pk_{aw}rn, h), where rn is the random number used for encryption. Therefore, the user can obtain statement′=(rt, pub, g, pkₐᵤ, C_{id}) and witness'=(path_{id}, CH_{id}, x, h, priv, r′, rn). The user uses the zk-SNARK proving algorithm Prove(pk_{idproof}, statement′, witness′) to generate the proof π_{id}. Finally, the user gets the identity proof proof_{id}=(statement′, π_{id}) about the identity id.

Further, the method of verifying identity proof: each verification node invokes the zk-SNARK verification algorithm Verify(vk_{idproof}, proof_{id}) to verify whether the user knows that the witness' makes (statement′, witness′) satisfy the relation R_{idproof} If the verification is successful, the identity proof is valid; otherwise, the verification of the identity proof fails.

Further, the regulator extracts the ciphertext set C={C_{id}_{ᵢ}}_{id}_{ᵢ}_{∈I} from the blockchain data data_{trace}. For each ciphertext C_{id}_{ᵢ} in C, the regulator computes hᵢ=Γ.DEC (skₐᵤ, C_{id}), searches the (h, id, CH_{id}) record, obtains the idᵢ corresponding to hᵢ and adds the idᵢ to the users' identity set ID. Finally, the regulator obtains the users' identity set ID corresponding to data_{trace}.

The presently disclosed method can include following main components:

### 1. A Blockchain Data Model

In many blockchain applications, every user generally has public information (pub), such as public key address, serial number, and corresponding private information, for example, private key address, signing private key. The public information is generated by the private information. For example, the public address and private key are the ECDSA's public/private key in Bitcoin, or the public key address is generated by the private key address via pseudorandom function in Zerocash. Therefore, there is a generation relationship between the users' public information and private information, i.e., pub=gen(priv). However, whatever way the blockchain uses to generate public/private information, the user who wants to operate some data of the blockchain must have the corresponding private information. In other words, the private information guarantees the user's unique power of operating data.

The blockchain can be viewed as a distributed database, on which data is stored. The untraceable data model in the blockchain is as follows:

data_{untrace}=[U,data_{body}]_{crytool}.

where U denotes the users' public information set that requires identity proofs, data_{body} denotes the data body, which is also includes the users' public information set that does not require any identity proof, and crytool denotes the cryptographic tools that guarantee blockchain features such as tamper-resistance and privacy protection.

U={A_{create}, Bₒₜₕₑᵣ), A_{create}={a₁, . . . , aₙ} denotes the public information set of the users who directly participate in data creation. aᵢ(1≤i≤n) denotes the public information of the user Pᵢ, such as public address, serial number. A_{create} may be empty. For example, because of the linkability among transactions in Bitcoin, the users only provide identity proofs for output addresses to achieve the trackable goal. Bₒₜₕₑᵣ={b₁, . . . , b_{n′}} denotes the public information set of the users who indirectly participate in data creation. Bₒₜₕₑᵣ is used to receive data, such as the output addresses in Bitcoin. Bₒₜₕₑᵣ may be empty, such as in some blockchain applications, a user only creates the data stored in the blockchain and does not require others to participate.

A main aspect of the presently disclosed traceable mechanism is that identity proofs are added to the blockchain data. FIG. 1 shows the data model in the traceable mechanism of the blockchain:

data_{trace}=[{proof_{id}}_{id∈I},data_{body}]_{crytool}

where {proof_{id}}_{id∈I} denotes the identity proof set of users and is used to replace the U in data_{untrace}. I is the user identity set that requires identity proofs, |I|=|U|.
proof_{id} denotes the identity proof of the user whose identity is id.

### 2. An Overview of the Blockchain Traceable Scheme

It is assumed that the regulator has generated the public parameter pp=(pk_{loginfo}, vk_{loginfo}, pk_{idproof}, vk_{idproof}, pkₐᵤ, pp_{chash}) according to the Setup algorithm of the traceable scheme in the next section, where (pk_{loginfo}, vk_{loginfo}) is the zk-SNARK proving/verification key for proving (statement, witness)∈R_{loginfo}, (pk_{idproof}, vk_{idproof}) is the zk-SNARK proving/verification key for proving (statement′, witness′)∈R_{idproof} the relation R_{loginfo} and R_{idproof} are described below, pkₐᵤ is the public key of the regulator, and pp_{chash}=(p, q, g) is the chameleon hash public parameter. The traceable scheme of the presently disclosed method is briefly outlined from the following aspects.

1) User Registration

The user obtains the chameleon hash public and private key pair (h, x) by invoking cham_hash.KeyGen(pp_{chash}) algorithm, and then computes his id's chameleon hash value: CHₜₐ=cham_hash.Chash(h, id, r)=g^{id}h^{r} mod p. Therefore, the user can obtain statement=(id, g, h, CH_{id}) and witness=(x, r). The user must prove to the regulator that (statement, witness) satisfies the relation R_{loginfo}: h=g^{x} and CH_{id}=g^{id} h^{r}, that is, “given the statement, the user knows that the witness satisfies: (1) the chameleon hash public key is computed correctly: h=g^{x}; (2) the chameleon hash value CH_{id} is computed correctly: CH_{id}=g^{id}h^{r}”.

The user uses the zk-SNARK proving algorithm Prove (pk_{loginfo}, statement, witness) to generate the proof π_{loginfo}. π_{loginfo} is used to prove to the regulator that the user knows that the witness makes the (statement, witness) satisfy the relation R_{loginfo}, but does not disclose any information about the witness. Next, the user stores (id, g, h, CH_{id}, x, r), encrypts (statement, π_{loginfo}) using the public key of the regulator to obtain the registration information C_{loginfo}, and sends C_{loginfo} to the regulator.

When the regulator receives the registration information C_{loginfo}, it will decrypt the C_{loginfo} and obtain (statement, π_{loginfo}). Next, the regulator first verifies the identity id and then invokes the zk-SNARK verification algorithm Verify(vk_{loginfo}, statement, π_{loginfo}) to verify whether the user knows that the witness makes (statement, witness) satisfy the relation R_{loginfo} If the verification is successful, the regulator stores (h, id, CH_{id}), and publishes h∥CH_{id} stored in the Merkle tree. Once the user finds that his h∥CH_{id} is made public, it means that he has successfully registered.

2) Generating and Verifying the Identity Proof

Generating identity proof: a user who registers successfully can obtain the path path_{id} about his h∥CH_{id} from the Merkle tree published by the regulator. Then, according to the public/private information (pub, priv), the user can calculate a value r′=cham_hash. UForge(CK, id, r, priv). Next, the user computes ciphertext C_{id}=Γ.ENC (pkₐᵤ, rn, h), where rn is the random number used for encryption. Therefore, the user can obtain statement′=(rt, pub, g, pkₐᵤ, C_{id}) and witness'=(path_{id}, r′, rn). The user must prove to the verification nodes that (statement′,witness′) satisfies the relation R_{idproof}: pub=gen(priv), h=g^{x}, CH_{id}=chamₕₐₛₕ. CHash(h, priv, r′), C_{id}=Γ.ENC(pkₐᵤ, rn, h), and TreeBranch(rt, path_{id}, h∥CH_{id}), that is, “given the statement’, the user knows that the witness' satisfies: (1) The private information matches the public information: pub=gen(priv); (2) The chameleon hash private key x matches the chameleon hash public key h: h=g^{x}; (3) The chameleon hash CH_{id} is computed correctly:

CH_{id}=cham_hash. CHash(h, priv, r′); (4) The ciphertext C_{id} corresponds to the plaintext
h: C_{id}=Γ.ENC (pkₐᵤ, rn, h); (5) h∥CH_{id} appears as a leaf of a Merkle tree with the root rt: TreeBranch(rt, path_{id}, h∥CH_{id})”.

The user uses the zk-SNARK proving algorithm Prove (pk_{idproof}, statement′, witness′) to generate the proof π_{id}. π_{id} is used to prove to the verification nodes that the user knows that witness' makes the (statement′,witness′) satisfy the relation R_{idproof}, but does not disclose any information about the witness′. Finally, the user gets the identity proof proof_{id}=(statement′, π_{id}) about the identity id.

Verifying identity proof: each verification nodes invokes the zk-SNARK verification algorithm Verify(vk_{idproof}, proof_{id}) to verify whether the user knows that the witness' makes (statement′,witness′) satisfy the relation R_{idproof}. If the verification is successful, the identity proof is valid; otherwise, the verification of the identity proof fails.

3) Tracing of the Regulator

The regulator extracts the ciphertext set C={C_{id}_{ᵢ}}_{id}_{ᵢ}_{∈I} from the blockchain data data_{trace} and obtains hᵢ corresponding to idᵢ in identity set I by decrypting every ciphertext C_{id}_{ᵢ}. Then according to the record that stores each user's (h, id, CH_{id}), the regulator can determine the idᵢ corresponding to hᵢ and add the idᵢ to the users' identity set ID. Finally, the regulator obtains the users' identity set ID corresponding to data_{trace}.

As can be observed from the above overview of the traceable scheme, using the traceable scheme proposed by the presently disclosed method requires users participating in data creation to display public information (such as public key addresses, serial numbers) in the data. However, because public/private information pairs can be created arbitrarily, so as long as each public/private information is used only once, the privacy protection of the blockchain is not affected.

### 3. Construction of the Blockchain Traceable Scheme

Let Å=(Gen, Prove, Verify) denote the zk-SNARK scheme, Γ=(Setup, KeyGen, ENC, DEC) denote the public key encryption scheme, and cham_hash=(Setup, KeyGen, Chash, UForge) denote the chameleon hash scheme proposed by Hugo Krawczyk and Tal Rabin. The traceable scheme (Setup, Genloginfo, Verifyloginfo, Genidproof, Verifyidproof, Trace) is constructed below:

Setup
Input: security parameter λ
Output: public parameters pp
1. construct arithmetic circuit AC_{loginfo} for relation R_{loginfo};
2. construct arithmetic circuit AC_{idproof} for relation R_{idproof};
3. compute (pk_{loginfo}, vk_{loginfo})=Å.Gen(λ, AC_{loginfo})
4. compute (pk_{loginfo}, vk_{idproof})=Å.Gen(λ, AC_{idproof})
5. compute public parameters of public encryption scheme pp_{enc}=Γ.Setup (λ);
6. compute regulator's public/private key (pkₐᵤ, skₒₙ)=Γ.KeyGen(pp_{enc});
7. compute public parameters of chameleon hash scheme ppₘₐₛₕ=(p, q, g)=cham_hash. Setup(λ);
8. output pp=(pk_{loginfo}, vk_{loginfo}, pk_{idproof}, vk_{idproof}, pkₐᵤ, pp_{chash})

[symbol]

Genloginfo
Input: public parameters pp, user identity id
Output: ciphertext C_{loginfo}
1. compute chameleon hash scheme's public/private key (HK, CK)=(h, x)=cham_hash. KeyGen(pp_{chash});
2. compute chameleon hash value CH_{id}=cham_hash. CHash(HK, id, r);
3. set statement=(id, g, HK, CH_{id}), witness=(CK, r);
4. compute π_{loginfo}=Å.Prove(pk_{loginfo}, statement, witness);
5. compute C_{loginfo}=Γ.ENC(pkₐᵤ, m), where m=(statement, π_{loginfo})
6. user stores (id, g, HK, CK, r, CH_{id}), and output C_{loginfo}

[symbol]

Verifyloginfo
Input: ciphertext C_{loginfo}, regulator's private key skₐᵤ, and public parameters pp
Output: b, if b=1, verification succeeds; otherwise, verification fails.
1. compute m=Γ.DEC(skₐᵤ, C_{loginfo});
2. verify the validation of the identity id, if id is not valid, output b=0;
3. else:
   if Å.Verify(vk_{loginfo}, statement, π_{loginfo})=0, output b=0;
   else:
      (a) store(h, id, CH_{id});
      (b) publish h∥CH_{id} via Merkle tree;
      (c) output b=1

[symbol]

Genidproof
Input:
   user public information pub
   user private information priv
   chameleon hash CH_{id}
   user public/private key (HK, CK) for computing chameleon hash
   user identity id
   random element r for computing chameleon hash CH_{id}
   Merkle tree root rt
   path path_{id} from h∥CH_{id} to rt
   public parameters pp
Output: the identity proof proof_{id}
1. compute r′=cham_hash.UForge(CK, id, r, priv);
2. compute ciphertext C_{id}=Γ.Enc(pkₐᵤ, rn, h), rn is a random number that is used for encrypting;
3. set statement′=(rt, pub, g, pkₐᵤ, C_{id}), witness′=(path_{id}, CH_{id}, x, h, priv, r′, rn);
4. compute π_{id}=Å.Prove(pk_{idproof} statement′, witness′);
5. output proof_{id}=(statement′, π_{id})

[symbol]

Verifyidproof
Input: the identity proof proof_{id}, public parameters pp
Output: b, if b=1, verification succeeds; otherwise, verification fails.
1. parse proof_{id} as (statement′, π_{id});
2. if Å.Verify(vk_{idproof}, statement′, π_{idproof})=0, output b=0;
else, output b=1.

Trace
input: the blockchain data data_{trace}
output: identity set ID for data_{trace}
1. set ID=Ø;
2. extract C={C_{id}_{ᵢ}}_{id}_{ᵢ}_{∈I} from the blockchain data data_{trace};
3. for each C_{id}_{ᵢ}∈C;
   compute hᵢ=Γ.DEC(skₐᵤ, C_{id}_{ᵢ});
   search (h, id, CH_{id}) records, get idᵢ for hᵢ;
   put idᵢ in ID;
4. output ID.

The above scheme realizes the traceability of identity. However, certain blockchain applications hide sensitive information (sens_{info}). To permit a regulator to perform sensitive information analysis for determining whether the user operation is legal, the users who are directly involved in data creation must add sensitive information to the ciphertext C_{id}, i.e., C_{id}=Γ.Enc(pkₒₙ, rn, h∥sens_{info}), However, the user must prove that C_{id} is the ciphertext of h∥sens_{info}.

Compared with the existing techniques, the presently disclosed method can include one or more of the following benefits:

In user registration, the user generates registration information, encrypts the information and sends it to the regulator. The regulator only needs to perform the verification work, which reduces the workload of the regulator, and there is no need for a secure channel between each user and the regulator; the user uses zk-SNARK to make the regulator not aware of the secret information (i.e., evidence) that generated the registration information during the user registration process. In this way, as long as the regulator honestly performs the registration process, no one except the user can forge the identity proof of the user, which provides a degree of security guarantee; when the user creates the identity proof, because of knowing the trapdoor, the user can use other values such as the user's private key and other private information to construct CH_{id} via the chameleon hash scheme. This process does not reveal his own identity id and eliminates the need for the user to register with the regulator every time when the user wants to generate the identity proof. That is, the user only needs to register with the regulator only once, which reduces the overhead for the user and the regulator; when generating the user's identity proof, the user's private information priv is used to generate the chameleon hash value CH_{id}, and pub=gen(priv) is proved in the relation R_{idproof}. This way guarantees that only the user who knows the private information priv can generate proof_{id}, and others cannot tamper with the user's proof_{id}. Therefore, the user can expose his own proof_{id}, so that when others create data, they do not need to interact with the user to get proof_{id}, reducing overhead.

The positive effects of the presently disclosed method are as following. For the actual needs of the development of the blockchain, the presently disclosed method proposes a blockchain traceable scheme, which can combine existing privacy protection technology to provide controllable anonymity mechanism. This scheme allows only the regulator to monitor data in the blockchain, and obtain the user's private information, such as user identity, data content, while others cannot obtain user private information. Therefore, the regulator can effectively crack down on illegal and criminal activities in the blockchain by supervising the blockchain data via the traceable scheme, which ensures healthy and stable development of the blockchain.

### BRIEF DESCRIPTION OF THE DRAWINGS

FIG. 1 shows a data model in the blockchain traceable mechanism in accordance with some embodiments of the present invention.

FIG. 2 shows a process of the blockchain traceable mechanism in accordance with some embodiments of the present invention.

### DETAILED DESCRIPTION OF IMPLEMENTATIONS

The blockchain traceable scheme in the presently disclosed method can combine existing privacy protection technology to provide controllable anonymity mechanism for blockchain. With reference to FIG. 2, concrete implementing ways of the presently disclosed method are described as follows:

1) The regulator first calls the Setup algorithm to generate the public parameters pp;

2) Each user invokes the Genloginfo algorithm to generate his own registration information C_{loginfo} and sends it to the regulator;

3) The regulator calls the Verifyloginfo algorithm to verify the registration information of each user, and then publishes h∥CH_{id} corresponding to each user's identity. Once the user finds that his h∥CH_{id} is made public, it means that he has successfully registered.

4) After the user is successfully registered, if the data in the blockchain application needs to the public information and identity proof of the users who indirectly participate in data creation, such as the output addresses in Bitcoin. At this time, each user, who indirectly participates in data creation, calls the Genidproof algorithm in advance to generate the user's identity proof proof_{id} and makes it public. In this way, each user in A_{create} can directly obtain the identity proof of the users in Bₒₜₕₑᵣ without having to interact with indirectly participating users. Next, each user in A_{create} invokes the Genidproof algorithm to create his own identity proof. Finally, the data data_{trace}=[{proof_{id}}_{id∈I}, data_{body}]_{crytool} is generated and sent to the node network;

5) Whenever the verification node in the node network receives the data, it first calls the algorithm Verifyidproof to verify the identity of the user, and then verifies the data contents. If the verification is successful, it is added in the block that is created by the verification node. And then the node network according to a consensus mechanism selects a final block which is added to the blockchain;

6) Once there is a new block on the blockchain, the regulator can obtain all the data in the new block and call the Trace algorithm to obtain the identity set corresponding to each data in the block, thereby achieving the blockchain supervision purpose.

The above implementing example are only used to illustrate the technical scheme of the present invention and not to limit it. Those skilled in the art can modify or equivalently replace the technical scheme of the present invention without departing from the spirit and scope of the present invention. The protection scope of the present invention shall be subject to the claims.

What is claimed is:

1. A method of data traceable for blockchain, comprising:
1) generating a public parameter pp by a regulator; generating the registration information C_{loginfo} by each user and sending it to the regulator;
2) verifying the registration information of each user by the regulator, and publishing h∥CH_{id} corresponding to each user's identity, where h is the chameleon hash public key, and CH_{id} is the chameleon hash value of the identity id;
3) when the data in the blockchain application needs to public information and identity proof of the users who indirectly participate in data creation, directly obtaining, by each user in A_{create}, the identity proof of the users in Bₒₜₕₑᵣ; creating, by each user in A_{create}, his own identity proof, generating the data data_{trace}=[{prof_{id}}_{id∈I}, data_{body}]_{crytool}, and sending the data to a node network, where {proof_{id}}_{id∈I} denotes the identity proof set of users, proof_{id} is the identity proof of the user whose identity is id, I is the user identity set that requires identity proofs, A_{create}={a₁, . . . , aₙ} denotes the public information set of the users who directly participate in data creation, Bₒₜₕₑᵣ={b₁, . . . , b_{n′}} denotes the public information set of the users who indirectly participate in data creation, data_{body} denotes the data body, which includes the users' public information set that does not require any identity proof, and crytool denotes the cryptographic tools;
4) when a verification node in the node network receives the data, verifying the identity proof of each user and the data contents; if the verification is successful, adding the data in the block that is created by the verification node according to a consensus mechanism, selecting a final block which is added to the blockchain by the node network; and
5) obtaining, by the regulator, the data from the blockchain, and decrypting a corresponding ciphertext in the data, and then querying relevant records to obtain the identity set corresponding to each data.

2. The method of claim 1, wherein the public parameter pp=(pk_{loginfo}, vk_{loginfo}, pk_{idproof}, vk_{idproof}, pkₐᵤ, pp_{chash}), where (pk_{loginfo}, vk_{loginfo}) is the zk-SNARK proving/verification key for proving (statement, witness)∈R_{loginfo}, (pk_{idproof}, vk_{idproof}) is the zk-SNARK proving/verification key for proving (statement′, witness′)∈R_{idproof}, pkₐᵤ is the public key of the regulator, wherein pp_{chash} is the chameleon hash public parameter, statement=(id, g, h, CH_{id}), witness=(x, r), the relation R_{loginfo}={(statement, witness)|h=g^{x}ΛCH_{id}=g^{id}h^{r} }, wherein statement′=(rt, pub, g, pkₐᵤ, C_{id}), witness′=(path_{id}, CH_{id}, x, h, priv, r′, rn), wherein the relation R_{idproof}={(statement′, witness′)|pub=gen(priv)Λh=g^{x}ΛCH_{id}=cham_hash.CHash(h, priv, r′)ΛC_{id}=Γ.ENC(pkₐᵤ, rn, h)ΛTreeBranch(rt, path_{id}, h∥CH_{id})}, wherein g is the element of order q in the multiplication cyclic group Zₚ*, x that is the private key of computing CH_{id} is a random element in the multiplication cyclic group Z_{q}*, r is the random number of computing CH_{id}, rt is the root of the Merkle tree, path_{id} is the path from h∥CH_{id} to rt, pub is the public information, priv is the private information, rn is the random number for encryption, wherein h∥CH_{id} corresponding to the identity of the registered user is exposed in the form of a Merkle tree.

3. The method of claim 2, wherein the user uses the zk-SNARK proving algorithm Prove(pk_{loginfo}) statement, witness) to generate the proof π_{loginfo}, wherein π_{loginfo} is used to prove to the regulator that the user knows that witness makes the (statement, witness) satisfy the relation R_{loginfo} but does not disclose any information about the witness, wherein the user next stores (id, g, h, CH_{id}, x, r), encrypts (statement, π_{loginfo}) using the public key of the regulator to obtain the registration information C_{loginfo} and sends C_{loginfo} to the regulator.

4. The method of claim 3, wherein when the regulator receives the registration information C_{loginfo} the regulator decrypts the C_{loginfo} and obtains (statement, π_{loginfo}), wherein the regulator verifies the identity id and invokes the zk-SNARK verification algorithm Verify(vk_{loginfo}, statement, π_{loginfo}) to verify whether the user knows that the witness makes the (statement, witness) satisfy the relation R_{loginfo}, wherein if the verification is successful, the regulator stores (h, id, CH_{id}), and publishes h∥CH_{id} stored in the Merkle tree.

5. The method of claim 3, wherein in the step of generating identity proof, after a user whose identity is id has successfully registered, the user obtains the path path_{id} about his h∥CH_{id} from the Merkle tree published by the regulator, based on the public/private information(pub, priv), the user calculates a value r′=cham_hash. UForge(CK, id, r, priv), wherein the user computes ciphertext C_{id}=Γ.ENC(pkₐᵤ, rn, h), where m is the random number used for encryption, wherein the user obtains statement′=(rt, pub, g, pkₐᵤ, C_{id}) and witness'=(path_{id}, CH_{id}, x, h, priv, r′, rn), wherein the user uses the zk-SNARK proving algorithm Prove(pk_{idproof}, statement′, witness′) to generate the proof π_{id}, wherein the user obtains the identity proof proof_{id}=(statement′, π_{id}) about the identity id.

6. The method of claim 5, wherein the step of verifying identity proof: each verification node invokes the zk-SNARK verification algorithm Verify(vk_{idproof}, proof_{id}) to verify whether the user knows that the witness' makes (statement′, witness′) satisfy the relation R_{idproof}, wherein if the verification is successful, the identity proof is valid; otherwise, the verification of the identity proof fails.

7. The method of claim 2, wherein the regulator extracts the ciphertext set C={C_{id}_{ᵢ}}_{id}_{ᵢ}_{∈I} from the blockchain data data_{trace}, wherein for each ciphertext C_{id}_{ᵢ} in C, the regulator computes hᵢ=Γ.DEC(skₐᵤ, C_{id}_{ᵢ}), searches the (h, id, CH_{id}) record, obtains the idᵢ corresponding to hᵢ and adds the idᵢ to the users' identity set ID, wherein the regulator obtains the users' identity set ID corresponding to data_{trace}.
